(19) United States
(12) Patent Application Publication
(10) Pub. No.: US 2007/0240393 A1
(43) Pub. Date: Oct. 18, 2007

(54) Air connection unit for an air filter housing

(75) Inventors: Klemens Dworatzek, Edingen (DE); Sascha Bauer, Auenwald (DE); Jochen Linhart, Schwaikheim (DE); Michael Fasold, Auenwald (DE)

Correspondence Address: CROWELL & MORING LLP;INTELLECTUAL PROPERTY GROUP, P.O. BOX 14300, WASHINGTON, DC, 20044-4300, US

(73) Assignee: MANN & HUMMEL GmbH, Ludwigsburg (DE)

(21) Appl. No.: 11/723,161

(22) Filed: Mar. 16, 2007

(30) Foreign Application Priority Data
Mar. 16, 2006 (DE) 10 2006 012 592.4

(51) Int. Cl. B01D 35/00

(52) U.S. Cl. 55/495

(57) ABSTRACT

In an air connection unit (10) for an air filter housing (20, 21) having at least one fitting (11) into which is integrated at least one maintenance interval indicator or maintenance switch connection (12) and which is rotatably supportable in an opening in the air filter housing (20), an air guiding element adjacent the fitting (11) is formed as a corrugated tube (14) over at least a portion of its length. This enables a simple alignment, substantially without restoring forces, of the maintenance switch connection (12) relative to the air filter housing (20).

### BACKGROUND OF THE INVENTION

This invention relates to an air connection unit for an air filter housing having at least one fitting into which is integrated at least one maintenance interval indicator or a maintenance switch connection and which is rotatably supportable in an opening in the air filter housing, and having an air guiding element adjacent the fitting.

Air filters are connected to the air intake system by air guiding components, e.g., pipes or hoses. A drawback of such arrangements is that any maintenance switch connections integrated in the components are always in the same fixed position. Also, when angled connections are used, there is always a fixed relative fitting position between the unfiltered air and the filtered air. Since it is necessary, however, to vary the position of the fitting and the maintenance switch connections depending on the configuration of the engine compartment and the installation situation, individually adapted components must be provided for each vehicle type.

U.S. Pat. No. 5,882,367 discloses an air connection unit with a rotatably supportable angled fitting for an air filter housing into which a maintenance switch connection is integrated. However, the position of the maintenance switch connection depends on the position of the connection fitting. In addition, an adapted fitting is needed for every angle required. Added to this are technical tolerances with regard to the position and distance of the connection geometry and possible engine add-on components that may be located in direct proximity. If the installation position is incorrect and/or the tolerances are too large, very large forces occur during installation, which can stress the components over their entire service life.

### SUMMARY OF THE INVENTION

Thus, it is an object of the present invention to provide an improved arrangement for establishing an angled connection between an air filter and a connected air guiding component.

Another object of the invention is to connect the intake system of an internal combustion engine to the air filter in such a way that the length and angle of the filtered air connection can be varied.

A further object of the invention is to provide an air connection unit for an air filter housing which enables the position of a maintenance switch connection to be freely varied.

These and other objects are achieved in accordance with the present invention by providing an air connection unit for an air filter housing, the connection unit being rotatably supportable in an opening in the air filter housing and comprising a fitting for a maintenance interval indicator or maintenance switch connection and an air guiding element adjacent the fitting, wherein the air guiding element is constructed over at least a portion of its length as a bendable corrugated tube.

As used herein the term “corrugated tube” refers to bendable corrugated tubes as well as tubes with a pleated geometry that can be bent without buckling or constricting the tubular enclosure.

Because of the rotatability of the fitting, the position of the maintenance switch connection can be freely selected. The position of the filtered air connection can be selected independently of the maintenance switch position. As a result, the position, length and angle of the connection are freely selectable.

Forming the air guiding element, or parts thereof, as a corrugated tube enables a flexible line installation even where space is tight, e.g., in an engine compartment.

In addition, the system is not sensitive to possible tolerances of the distances to the components to be connected or their position. Regardless of whether the position or the distance varies, the flexible fitting can be connected to the intake system with little effort. The restoring forces acting on the components when the corrugated tube is elastically deformed are low, even over the long term, or they disappear altogether if a certain configuration in a crease geometry is adjusted.

The angled section of the air guiding element formed as a corrugated tube should form a 45° to 150°, particularly a 90° angle in its unstressed state. Because of the flexibility of the corrugated area, most simple deflections of the air guiding element can be realized.

The air guiding element preferably terminates in a connecting collar. This is a shoulder at the end of the tube around which a tube clip may be placed and with which the connecting collar can be firmly pressed against a coupling.

To realize two deflections on the air guiding element, the element should have two angled sections formed as corrugated tubes and an S-shaped configuration, i.e., the curved sections lie in one plane but the inlet and outlet openings point in different and, in particular, opposite directions. By placing a plurality of corrugated tube sections end to end, this principle can be expanded to practically any number of deflections desired.

The described configurations apply to the initial unstressed or unbent state. Based thereon, the corrugated tube sections can be either permanently bent or flexibly bent back to adapt them to the planned path of the air line inside an engine compartment.

It is particularly advantageous to form the air guiding element with a connecting collar between the angled sections as well as at the ends. This makes it possible, on the one hand, to provide an additional connecting element on the connecting collar between the angled sections for attaching the air guiding element to an additional point in the engine compartment. On the other hand, it is also possible in this embodiment to produce and deliver a configuration that allows a plurality of deflections but may also, if necessary, be cut off directly behind the central connecting collar if only a single deflection is required. The extra costs of the additional angled section are so low for a blow-molded plastic part that it may be cheaper to offer this section to the customer from the outset rather than to manufacture and sell two different types of air connection units and keep them in inventory for spare parts requirements.

It may also be provided that the angled sections are connected with each other in an airtight manner by a bell-and-spigot joint. As a result, the air guiding element does not need be cut to adapt it to different situations. Instead, the second angled section that is not needed can simply be removed.

### BRIEF DESCRIPTION OF THE DRAWINGS

The invention will now be described in further detail with reference to illustrative preferred embodiment s shown in the accompanying drawings, in which:

FIG. 1 is a perspective view of an air filter housing with a air connection unit according to the present invention;

FIG. 2 is a side view of the air filter housing and air connection unit of FIG. 1;

FIG. 3a shows the air filter housing with a S-shaped air connection unit comprising two bendable corrugated sections, and

FIG. 3b shows the air filter housing with a two-part air connection unit each comprising a bendable corrugated section.

### DETAILED DESCRIPTION OF PREFERRED EMBODIMENTS

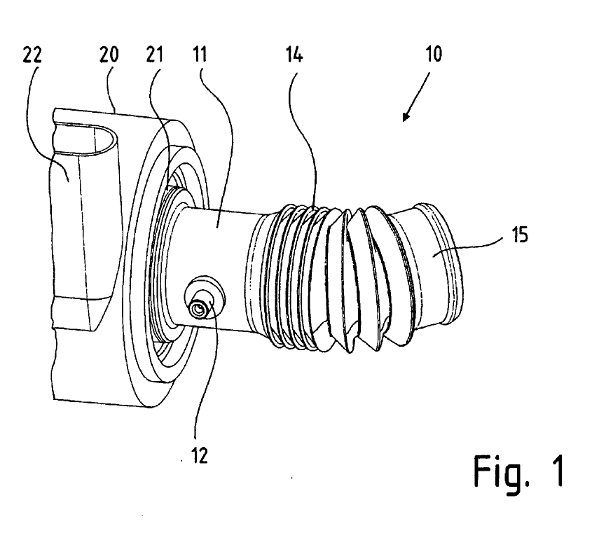

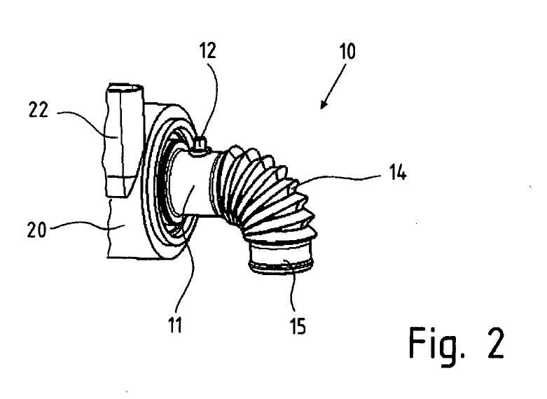

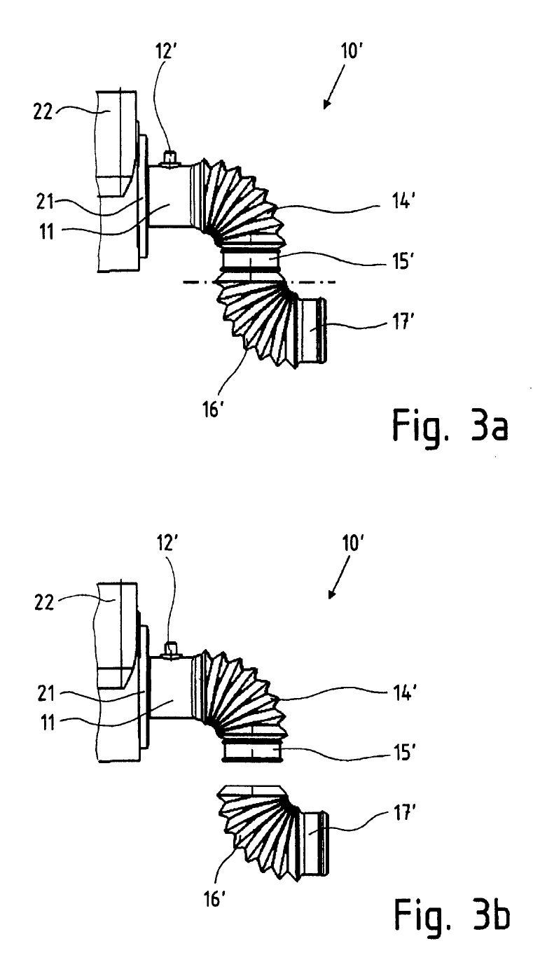

FIG. 1 shows details of an air filter housing 20 with an air inlet fitting 22. This fitting is shown in this illustration as well as in the following FIGS. 2 and 3 to indicate that the position of the air filter housing 20 is unchanged in all the figures.

The illustrated embodiment is a cylindrical air filter housing for a round filter with a central opening on a mounting flange 21 on the filtered air side. An air connection unit can be connected to this opening to link the air filter housing to other modules in an engine compartment, e.g., to an intake module of an internal combustion engine.

A fitting 11 is inserted into the mounting flange 21. A portion of the fitting 11 is received in the mounting flange 21 or the air filter housing 20, where it is snapped into place or fastened in some other manner so that rotation is possible but axial tensile forces can be absorbed at the fitting.

In the projecting portion of the fitting 11, a maintenance switch connection 12 is disposed. This is a branch of the air pipe formed within the fitting to enable a thin hose line to be guided to a distal pressure sensor. A suitable sensor to measure a pressure drop due to dirt accumulation in the air filter may also be mounted directly on the fitting 11.

An angled section 14 that can be deformed via a pleated geometry is adjacent the fitting 11, so that the center axis at the end configured as a connecting collar 15 to receive a tube clip can be adjusted to an approximately 45° angle (as here) relative to the center axis of the fitting 11.

FIG. 2 shows the same embodiment of the air connection unit 10, in which the fitting 11 is rotated relative to the position depicted in FIG. 1 such that the maintenance switch connection 12 is on top. The air guiding element, which can be twisted independently of the position of the fitting 11, is bent downward by 90° together with its connecting collar 15.

FIG. 3a shows a second embodiment of an air connection unit 10′, in which the air guiding element includes two angled sections 14′, 16 that are interconnected by a central connecting collar 15′. An additional fastening or mounting element may be arranged at this point. The link with additional modules is effected at the connecting collar 17′ at the end of the second angled section 16′.

If the second angled section 16′ is not required, it may be detached along the broken line in FIG. 3a.

After the lower angled section 16′ has been detached, as shown in FIG. 3b, a configuration is obtained that corresponds to the first embodiment illustrated in FIGS. 1 and 2. The end of the connecting collar 15′ is configured like the connecting collar 17′ and can therefore be connected to other conducting components using the same fastening elements.

The foregoing description and examples have been set forth merely to illustrate the invention and are not intended to be limiting. Since modifications of the described embodiments incorporating the spirit and substance of the invention may occur to persons skilled in the art, the invention should be construed broadly to include all variations within the scope of the appended claims and equivalents thereof.

What is claimed is:

1. An air connection unit for an air filter housing, said connection unit being rotatably supportable in an opening in the air filter housing and comprising a fitting for a maintenance interval indicator or maintenance switch connection and an air guiding element adjacent the fitting, wherein the air guiding element is constructed over at least a portion of its length as a bendable corrugated tube.

2. An air connection unit according to claim 1, wherein at least one angled section of the air guiding element which is constructed as a corrugated tube forms in an unstressed state a 30° to 140° angle.

3. An air connection unit according to claim 1, wherein the air guiding element terminates in a connecting nipple with an annular connecting rib.

4. An air connection unit according to claim 1, wherein the air guiding element is constructed as a tube having two angled corrugated sections and has an S-shaped configuration.

5. An air connection unit according to claim 4, wherein the air guiding element is constructed in two pieces with an angled section in each piece and a connecting collar joining the two pieces between the angled sections and terminates in a connecting nipple with an annular connecting rib.

6. An air connection unit according to claim 5, wherein the angled sections are interconnected in an airtight manner via a nipple and sleeve connection.

7. In combination, an air filter housing having a support opening for an air connection unit, and an air connection unit according to claim 1 rotatably received in said support opening.
